(19) United States
(12) Patent Application Publication
(10) Pub. No.: US 2011/0154592 A1
(43) Pub. Date: Jun. 30, 2011

(54) CLEANING SYSTEM

(76) Inventor: Sew Hing Woo, Hertfordshire (GB)

(21) Appl. No.: 12/998,005

(22) PCT Filed: Sep. 8, 2009
(86) PCT No.: PCT/GB2009/002151

§ 371 Date: Mar. 8, 2011

(30) Foreign Application Priority Data
Sep. 8, 2008 (GB) 0816332.1

(51) Int. Cl. B08B 9/04

(52) U.S. Cl. 15/104.061

(57) ABSTRACT

The present invention relates to a cleaning system that does not require the use of electrical energy to power electrical motor or pump and the like to clean condenser fins but instead uses differential in pressure between two separated chambers and magnets.

This invention relates to a cleaning system. The cleaning system may be used to clean condenser fins. In particular, the cleaning system that does not require the use of electrical energy to power electrical motor or pump and the like to clean condenser fins but instead uses differential in pressure between two separated chambers and magnets.

One of the main mechanical components in the refrigeration plant apart from the compressors, are condensers. A condenser is a heat transfer unit that includes copper pipes with narrowly spaced layers of fins pressed fitted to the copper pipes. To carry out the heat transfer function, air is drawn though the heat transfer unit by fans in the heat transfer unit. As the air passes by the copper pipes and fins, heat is transferred from the pipes and fins to the air; thereby cooling the contents of the pipes.

However, the drawback with using air to cool in this way is that, as the air is drawn in from the surrounding areas, the air also carries dirt and debris. Over time, the accumulation of dirt and debris on the outside of the pipes and fins will restrict the air flowing through the fins. This restriction means that less air passes through the fins. Consequently, less heat is dissipated from the condenser and the efficiency of the condenser is reduced.

A common way to overcome this problem is to clean the fins manually by brushing and washing the fins with a cleaning detergent and/or directing high pressure jet stream of air to dislodge the dirt and debris. The main disadvantage to this method is the frequency of cleaning is periodic. It is not cost effective to clean the condensers continuously.

An alternative method is described in U.S. Pat. No. 6,792,769 which discloses a cleaning system for refrigerator condenser where a timing device in the system causes the rotation of the fan motor to reverse and thereby expel the dirt and debris that has accumulated on the pipes.

Yet another method is described in US Patent Application, Publication Number 2006260654 which discloses a method and apparatus for cleaning exterior condensers by using a vehicle and a pump coupled to the vehicle; and fluidly connected to a fluid source.

Finally, U.S. Pat. No. 5,336,331 discloses a condenser cleaning system where a hollow wand is supported by a carriage. The hollow wand is moved by a hollow shaft and a pump communicating with the said hollow shaft for pumping fluid. There is also a recovery tank for receiving cleaning fluid.

All the above US patents require the use of a motor or pump to carry out the cleaning. Therefore what is desired is an alternative efficient way to clean the condenser.

### SUMMARY OF THE INVENTION

According to the present invention there is provided cleaning system comprising a pipe; a plurality of valves in communication with the pipe; a high pressure source in communication with the pipe through at least one valve; a low pressure source in communication with the pipe through at least one valve; an inner unit; and an outer unit including a cleaning unit; wherein the inner unit and outer unit are arranged to be attracted to each other using magnetism such that movement of the inner unit causes movement of the outer unit thereby enabling cleaning of a surface remote from the inner unit.

The present invention by enabling a remote unit including a cleaning unit, such as a brush, to be manipulated enables cleaning of a surface remote from the inner unit.

The inner unit may optionally comprise a hollow tube sealed at either end or be solid. The inner unit has an outer circumference corresponding to the inner surface of the pipe.

The inner unit may include at least one magnet and the magnet may be fitted near to the outer diameter of the inner unit. Alternatively, the inner unit may itself be a magnet. Optionally, the outer unit may be made from magnetisable material so that it can be moved by the inner unit.

The outer unit may include at least one magnet and the magnet may be fitted near to the inner diameter of the outer unit. Alternatively, the outer unit may itself be a magnet. Optionally, the inner unit may be made from magnetisable material so that it can move the inner unit.

The cleaning unit may be a brush. Further, the cleaning unit may include a spring to provide flexibility in movement. Optionally, the cleaning unit may be adjustable in height to ensure positive contact with the fins surface.

The pipe may form part of a closed system.

The system may include means to control a change in pressure within the pipe. The means may be, for example an electronic timer, a mechanical timer or a velocity sensor.

Other aspects and features of the present invention will become apparent to those ordinarily skilled in the art upon review of the following description of specific embodiments of the invention in conjunction with the accompanying figures.

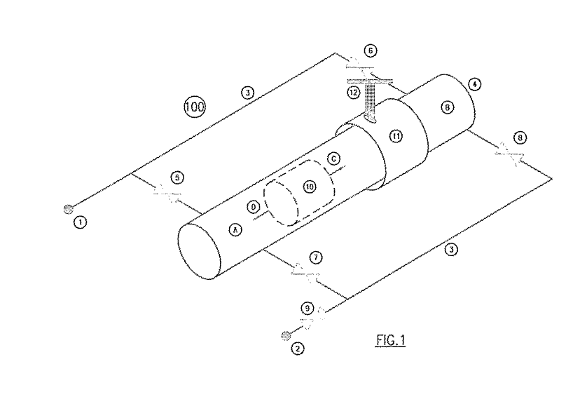

FIG. 1 illustrates a cleaning system of the present invention;

FIG. 2 illustrates an outer unit of the cleaning system; and

FIG. 3 illustrates an inner unit of the cleaning system.

The cleaning system of the present invention is illustrated in FIG. 1. The cleaning system includes an inner unit 10 and an outer unit. The cleaning system is present within a pipe 4, dividing the pipe 4 into two separate chambers A and B.

The pipe 4 is in communication with capillary tubes 3. The capillary tubes are have pressure sources at ends (1) and (2) and are in communication with an arrangement of valves (5), (6), (7), (8) and (9).

As can be seen in FIG. 2 the outer unit of the cleaning system includes an outer sleeve 11 and a cleaning unit, which in this case, is a brush (12). The brush 12 is used to clean the fins of the condenser and is mounted securely onto the outer sleeve 11. The outer brush 12 may be mounted using any suitable means, for example, it may be held in place by an interference fit between the brush's handle and a cavity in the outer sleeve 11, an interference fit between a projection from the outer sleeve 11 and the inside of a hollow handle in the brush 12. Alternatively, the brush 12 may be attached to the outer sleeve 11 by means of a screw thread.

The outer sleeve 11 is sized to be able to run freely along the outer circumference of the pipe 4. The outer sleeve 11 may include one or more magnets 13 and, preferably, a ring of magnets 13. The magnets 13 are preferably placed near to the circumference of the outer sleeve 11.

The outer sleeve 11 is preferably made from a low co-efficient of friction material to aid in the movement. Other methods may include fitting loose ball bearings to the outer sleeve 11. Suitable lubricant may be used to aid movement.

The inner unit 10 of the present invention is illustrated in FIG. 3. The inner unit 10 is sized to run freely through the inside of the pipe 4. The inner unit 10 may be made from a magnetisable material, for example mild steel. Alternatively, the inner unit 10 may include one or more magnets. Preferably, the magnets are placed near to the outer diameter and may be in any suitable configuration. Preferably, the inner unit 10 is made from a low co-efficient friction material to aid in the movement of the inner unit 10 through the pipe 4. Other methods may include fitting loose ball bearings to the inner unit. Suitable lubricant may be used to aid movement.

The inner unit 10 and outer unit are arranged to be attracted to each other through magnetic forces and are held in alignment with each other when placed in the pipe with the pipe separating the inner unit 10 and outer unit.

A method of using the cleaning system will now be described with reference to FIG. 1. Initially, high pressure is introduced from end 1 into the pipe 4 via capillary tube 3 and through valves 5 and 6. Valves 7 and 8 are closed. Chambers A and B are therefore both at high pressure.

To create a differential in pressure between the two chambers, valve 5 remains open, valve 6 is closed, valve 7 remains shut and valve 8 is opened.

Valve 8 is in communication with a low pressure source at end 2 and because valve 8 is open, the pressure in chamber B drops. Chamber A is therefore at a higher pressure than chamber B. It is preferable that the pressure in chamber B is reduced gradually; hence valve (9) is fitted prior to low pressure source.

As chamber A has a higher pressure than chamber B, the inner unit 10 moves in direction C.

When the inner unit 10 moves in direction C, outer sleeve 11 moves in the same direction and at the same rate due to the magnetic forces between the inner unit 10 and the outer sleeve 11.

As the brush 12 is securely mounted to the outer sleeve 11, the brush 12 moves with the outer sleeve 11 in direction C. This movement of the brush cleans the fins without using motor or pump but by using a differential in pressure between two separated chambers and magnetism.

To move the inner unit 10 in the opposite direction i.e. from chamber B to A; valve 5 is closed, valve 6 is opened, valve 7 is opened and valve 8 is closed. Valve 7 is in communication with low pressure source at end 2 and because valve 7 is opened, the pressure in chamber A drops. Chamber B is therefore at a higher pressure than chamber A. It is preferable to drop in pressure gradually in chamber A. Valve 9 is fitted prior to the low pressure source and acts to control the rate of drop in pressure in Chamber A.

The inner unit 10 moves in direction D.

When the inner unit 10 moves in direction D, outer sleeve 11 moves in the same direction and at the same rate due to the magnetic forces between the inner unit 10 and the outer sleeve 11.

As the brush 12 is securely mounted to the outer sleeve 11, the brush 12 moves with the outer sleeve 11 in direction D. This movement of the brush 12 cleans the fins without using motor or pump but by differential in pressure between two separated chambers and magnetism.

The above process may be repeated and the fins can thus be cleaned automatically, repeatedly and continuously without the use of motor or pump.

Although the present invention has been described with magnets always being present in the outer unit, as will be understood by one skilled in the art the outer unit may be made from a magnetisable metal and the inner unit 10 include magnets 13 to attract the outer unit to the inner unit 10.

Any suitable means may be used to control the change in pressure and thus direction of movement of the cleaning unit. For example, the control may be via an electronic or mechanical timer, or through sensing the velocity. The control may be automated or controlled manually through a computer system or manual manipulation of valves.

1. A cleaning system comprising
(a) a pipe;
(b) at least one valve in communication with the pipe;
(c) a high pressure source in communication with the pipe through the at least one valve;
(d) a low pressure source in communication with the pipe through the at least one valve;
(e) an inner unit; and
(f) an outer unit including a cleaning unit; wherein the inner unit and outer unit are arranged to be attracted to each other using magnetism such that movement of the inner unit causes movement of the outer unit thereby enabling cleaning of a surface remote from the inner unit.

2. The cleaning system of claim 1 wherein the inner unit has an outer circumference corresponding to the inner surface of the pipe and is one of the group comprising a hollow tube sealed at either end and a solid tube.

3. The cleaning system of claim 1, wherein the inner unit further includes at least one magnet.

4. The cleaning system of claim 3, wherein the magnet of the inner unit are fitted near to the outer diameter of the inner unit.

5. The cleaning system of claim 1 wherein the inner unit comprises a magnet.

6. The cleaning system of claim 3, wherein the outer unit is made from magnetisable material.

7. The cleaning system of claim 1, wherein the outer unit further includes at least one magnet.

8. The cleaning system of claim 7, wherein the at least one magnet of the outer unit are fitted near to the inner diameter of the outer unit.

9. The cleaning system of claim 1, wherein the outer unit comprises a magnet.

10. The cleaning system of claim 7, wherein the inner unit is made from magnetisable material.

11. The cleaning system of claim 1, wherein the cleaning unit is a brush.

12. The cleaning system of claim 1, wherein the cleaning unit includes a spring to provide flexibility in movement.

13. The cleaning system of claim 1, wherein the cleaning unit is adjustable in height to ensure positive contact with the fins' surface.

14. The cleaning system of claim 1, wherein the pipe forms part of a closed system.

15. The cleaning system of claim 1, further including control means to control a change in pressure within the pipe.

16. The cleaning system of claim 15 wherein the control means is one of the group comprising an electronic timer, a mechanical timer and a velocity sensor.

17. (canceled)

18. The cleaning system of claim 5, wherein the outer unit is made from magnetisable material.

19. The cleaning system of claim 9, wherein the inner unit is made from magnetisable material.
